(19) United States
(12) Patent Application Publication
(10) Pub. No.: US 2018/0024397 A1
(43) Pub. Date: Jan. 25, 2018

(54) LIQUID CRYSTAL DISPLAY DEVICE AND METHOD FOR MANUFACTURING SAME

(71) Applicant: LG CHEM, LTD., Seoul (KR)

(72) Inventors: Ilha LEE, Daejeon (KR); Ji Young HWANG, Daejeon (KR); Seung Heon LEE, Daejeon (KR); Dong Hyun OH, Daejeon (KR); Ki-Hwan KIM, Daejeon (KR); Han Min SEO, Daejeon (KR); Chan Hyoung PARK, Daejeon (KR)

(73) Assignee: LG CHEM, LTD., Seoul (KR)

(21) Appl. No.: 15/546,890

(22) PCT Filed: May 2, 2016
(86) PCT No.: PCT/KR2016/004624

§ 371 Date: Jul. 27, 2017

(30) Foreign Application Priority Data
Apr. 30, 2015 (KR) 10-2015-0062002

(51) Int. Cl. G02F 1/1335; G02F 1/1337; G02F 1/1343; G02F 1/1362

(52) U.S. Cl. CPC G02F 1/133502; G02F 1/136286; G02F 1/1337; G02F 1/13439; G02F 1/134309; G02F 2001/136222; G02F 2201/123; G02F 2201/121

(57) ABSTRACT

The present specification relates to a liquid crystal display device and a method for manufacturing the same.

### TECHNICAL FIELD

The present specification relates to a liquid crystal display device and a method for manufacturing the same.

### BACKGROUND ART

Liquid crystal display devices are a most important display device used in recent multimedia society, and have been widely used from portable phones to computer monitors, laptops and televisions. As a liquid crystal display device, there is a TN mode in which a liquid crystal layer twist arranging nematic liquid crystals is placed between two orthogonal polarized plates, and an electric filed is applied in a direction perpendicular to a substrate. When a black color is displayed in such a TN mode type, double refraction caused by liquid crystal molecules occurs in an inclined viewing angle and light leakage occurs since liquid crystals are oriented in a direction perpendicular to a substrate.

In view of a viewing angle problem of such a TN mode type, an in-plane switching (IPS) mode in which two electrodes are formed on one substrate, and a liquid crystal director is controlled by a transverse electric field generated between the two electrodes has been introduced. In other words, the IPS mode type is also referred to as an in-plane switching liquid crystal display or a transverse electric field-type liquid crystal display, and by disposing electrodes in the same plane in a liquid crystal-disposed cell, the liquid crystals are lined up parallel to the transverse direction of the electrode instead of being lined up in a perpendicular direction.

However, in the IPS mode type, there may be a problem in that high-definition is difficult to obtain due to high light reflectance of a pixel electrode and a common electrode.

### DISCLOSURE

### Technical Problem

The present specification is directed to providing a liquid crystal display device capable of obtaining a high-definition display by controlling a glare phenomenon caused by an electrode provided in a pixel of the liquid crystal display device, and a method for manufacturing the same.

### Technical Solution

One embodiment of the present specification provides a liquid crystal display device including a substrate; a plurality of gate lines and a plurality of data lines provided to cross each other on the substrate; a plurality of pixel regions divided by the gate lines and the data lines; a color filter layer provided on each of the pixel regions; a pixel electrode and a common electrode corresponding thereto provided on the same plane of each of the color filter layers;

a liquid crystal orientation layer provided on the color filter layer, the pixel electrode and the common electrode; and a light reflection reducing layer provided each of between the liquid crystal orientation layer and the pixel electrode and between the liquid crystal orientation layer and the common electrode,

wherein one surface of the light reflection reducing layer adjoins the pixel electrode or the common electrode, the other surface of the light reflection reducing layer adjoins the liquid crystal orientation layer, and, in the light reflection reducing layer, the following Formula 1 satisfies a value of greater than or equal to 0.004 and less than or equal to 0.22.

Another embodiment of the present specification provides a method for manufacturing a liquid crystal display device including preparing a substrate; forming a plurality of gate lines and a plurality of data lines crossing each other to divide a plurality of pixel regions on the substrate; forming a color filter layer in each of the pixel regions; forming a pixel electrode and a common electrode on the color filter layer; forming a light reflection reducing layer on the pixel electrode and the common electrode; and forming a liquid crystal orientation layer on the color filter layer, the pixel electrode and the common electrode,

wherein one surface of the light reflection reducing layer adjoins the pixel electrode or the common electrode, the other surface of the light reflection reducing layer adjoins the liquid crystal orientation layer, and, in the light reflection reducing layer, the following Formula 1 satisfies a value of greater than or equal to 0.004 and less than or equal to 0.22.

$$\frac{( k \times t )}{λ} \qquad [ Formula 1 ]$$

In Formula 1, k means an extinction coefficient of the light reflection reducing layer, t means a thickness of the light reflection reducing layer, and λ means a wavelength of light.

### Advantageous Effects

A liquid crystal display device according to the present specification is capable of obtaining a high-definition display by controlling light reflectance caused by a pixel electrode and a common electrode.

### DESCRIPTION OF DRAWINGS

FIG. 1 illustrates an example of one pixel region of the present specification.

FIG. 2 illustrates a section of a liquid crystal display device according to one embodiment of the present specification.

FIG. 3 is a graph showing n and k values of a light reflection reducing layer of Example 1 depending on a wavelength.

FIG. 4 is a graph showing n and k values of a MoTi layer of Comparative Example 1 depending on a wavelength.

FIG. 5 compares reflectance of Example 1 and Comparative Example 1.

FIG. 6 shows reflectance of Example 13.

FIG. 7 shows reflectance of Example 14.

FIGS. 8 and 9 show reflectance and an optical constant value obtained from a structure manufactured in Example 15.

### REFERENCE NUMERAL

101a, 101b: Gate Line
201, 201a, 201b: Data Line
301: Thin Film Transistor
310: Gate Electrode
320: Semiconductor Layer
330: Source Electrode
340: Drain Electrode
401: Substrate
510, 520: Color Filter Layer
601: Common Electrode
701: Pixel Electrode
801: Light Reflection Reducing Layer
901: Liquid Crystal Orientation Layer
1010, 1020, 1030: Insulating Layer

### MODE FOR DISCLOSURE

In the present specification, a description of one member being placed “on” another member includes not only a case of the one member adjoining the another member but a case of still another member being present between the two members.

In the present specification, a description of a certain part “including” certain constituents means capable of further including other constituents, and does not exclude other constituents unless particularly stated on the contrary.

Hereinafter, the present specification will be described in more detail.

In the present specification, a display device is a term collectively referring to TVs, computer monitors and the like, and includes a display element forming images and a case supporting the display element.

A black matrix has been used in existing display devices in order for preventing light reflection, light leakage and the like. Recently, structures that do not use the above-mentioned black matrix have been developed by introducing a structure called a color filter on TFT array (COT or COA) forming a color filter on an array substrate together with a thin film transistor. By introducing a structure that does not use the black matrix, effects such as transmissivity enhancement, luminance enhancement and backlight efficiency improvement in a display device may be obtained. However, in a structure that does not use the black matrix, regions in which a metal electrode included in a display device is exposed increases leading to a problem caused by color and reflection properties of the metal electrode. Particularly, display devices have recently become large-sized and resolution thereof has increased, and as a result, technologies capable of reducing reflection and color properties caused by the metal electrode included in a display device described above have been required.

In view of the above, the inventors of the present disclosure have found out that, in a display device including a conductive layer such as a metal, visibility of the conductive layer is mainly affected by light reflection and diffraction properties caused by the conductive layer, and have tried to improve this phenomenon.

A liquid crystal display device according to one embodiment of the present specification introduces a light reflection reducing layer between a pixel electrode and a common electrode, and a liquid crystal orientation layer, and therefore, is capable of greatly improving visibility decline caused by high reflectance of the pixel electrode and the common electrode.

Specifically, the light reflection reducing layer has a light absorption property, and is capable of reducing light reflectance caused by the pixel electrode and the common electrode by reducing the amount of light incident to the pixel electrode and the common electrode themselves and the amount of light reflected from the pixel electrode and the common electrode.

One embodiment of the present specification provides a liquid crystal display device including a substrate; a plurality of gate lines and a plurality of data lines provided to cross each other on the substrate; a plurality of pixel regions divided by the gate lines and the data lines; a color filter layer provided on each of the pixel regions; a pixel electrode provided on the same plane of each of the color filter layers and a common electrode corresponding thereto; a liquid crystal orientation layer provided on the color filter layer, the pixel electrode and the common electrode; and a light reflection reducing layer provided each of between the liquid crystal orientation layer and the pixel electrode and between the liquid crystal orientation layer and the common electrode,

wherein one surface of the light reflection reducing layer adjoins the pixel electrode or the common electrode, the other surface of the light reflection reducing layer adjoins the liquid crystal orientation layer, and, in the light reflection reducing layer, the following Formula 1 satisfies a value of greater than or equal to 0.004 and less than or equal to 0.22.

$$\frac{( k \times t )}{λ} \qquad [ Formula 1 ]$$

In Formula 1, k means an extinction coefficient of the light reflection reducing layer, t means a thickness of the light reflection reducing layer, and λ means a wavelength of light.

When external light enters to an electrode provided with the light reflection reducing layer, first reflected light reflected on a surface of the light reflection reducing layer is present, and second reflected light passing through the light reflection reducing layer and reflected on a lower electrode surface is present.

The light reflection reducing layer may lower light reflectance through destructive interference of the first reflected light and the second reflected light.

The inventors of the present disclosure have found out that light reflectance of the pixel electrode and the common electrode is significantly reduced through destructive interference when the light reflection reducing layer in which Formula 1 satisfies a value of greater than or equal to 0.004 and less than or equal to 0.22 is provided adjoining the pixel electrode and the common electrode, and high resolution of a display is obtained.

Specifically, the condition of destructive interference obtained by the first reflected light and the second reflected light having a phase difference of 180 degrees is as in the following Formula 2.

$$t = \frac{λ}{4 \cdot n} \times N \qquad [ Formula 2 ]$$

In Formula 2, t means a thickness of the light reflection reducing layer, λ means a wavelength of light, n means a refractive index of the light reflection reducing layer, and N means any odd number such as 1, 3 and 5.

First reflectance under the condition of destructive interference may be obtained as in the following Formula 3.

$${R}_{1} = [ \frac{{( n - 1 )}^{2} + {k}^{2}}{{( n + 1 )}^{2} + {k}^{2}} ] \qquad [ Formula 3 ]$$

In Formula 3, n means a refractive index of the light reflection reducing layer and k means an extinction coefficient of the light reflection reducing layer.

Furthermore, second reflectance under the condition of destructive interference may be obtained as in the following Formula 4.

$${R}_{2} = {R}_{metal} ( 1 - {R}_{1} ) {I}_{0} exp ( - \frac{2 π}{n} \cdot k \cdot N ) \qquad [ Formula 4 ]$$

In Formula 4, Rₘₑₜₐₗ means reflectance on the surface of the pixel electrode or the common electrode, R₁ means first reflectance in the light reflection reducing layer, Iₒ means intensity of incident light, n means a refractive index of the light reflection reducing layer, k means an extinction coefficient of the light reflection reducing layer, and N means any odd number such as 1, 3 and 5.

According to one embodiment of the present specification, an absolute value of a difference between the first reflectance and second reflectance may be greater than or equal to 0.13 and less than or equal to 0.42.

According to one embodiment of the present specification, λ may be 550 nm. In other words, it may be light with a wavelength of 550 nm.

According to one embodiment of the present specification, the light reflection reducing layer may have a thickness of greater than or equal to 5 nm and less than or equal to 100 nm, and more preferably greater than or equal to 10 nm and less than or equal to 100 nm. Specifically, according to one embodiment of the present specification, the light reflection reducing layer may have a thickness of greater than or equal to 20 nm and less than or equal to 60 nm.

The light reflection reducing layer having a thickness of less than 10 nm may cause a problem of not sufficiently controlling light reflectance of the pixel electrode and the common electrode. In addition, the light reflection reducing layer having a thickness of greater than 100 nm may lead to a problem of patterning the light reflection reducing layer being difficult.

According to one embodiment of the present specification, the light reflection reducing layer may have an extinction coefficient (k) of greater than or equal to 0.1 and less than or equal to 2 in light with a wavelength of 550 nm. Specifically, according to one embodiment of the present specification, the light reflection reducing layer may have an extinction coefficient (k) of greater than or equal to 0.4 and less than or equal to 2 in light with a wavelength of 550 nm.

When the extinction coefficient is in the above-mentioned range, light reflectance of the pixel electrode and the common electrode may be effectively controlled, and visibility of the liquid crystal display device may be further improved accordingly.

The extinction coefficient may be measured using an ellipsometer measuring device and the like known in the art.

The extinction coefficient k is also referred to as an absorption coefficient, and may be a criterion capable of defining how strong a subject material absorbs light in a specific wavelength. Accordingly, first absorption occurs while incident light passes through the light reflection reducing layer with a thickness of t depending on the degree of k, and after second absorption occurs while light reflected by a lower electrode layer passes through the light reflection reducing layer with a thickness of t again, external reflection occurs. Accordingly, thickness and absorption coefficient values of the light reflection reducing layer act as an important factor affecting total reflectance. As a result, according to one embodiment of the present specification, a region capable of reducing light reflection in certain absorption coefficient k and thickness t ranges of the light reflection reducing layer is shown through Formula 1.

According to one embodiment of the present specification, the light reflection reducing layer may have a refractive index (n) of greater than or equal to 2 and less than or equal to 3 in light with a wavelength of 550 nm.

First reflection occurs in a material of the light reflection reducing layer having a refractive index (n) together with an extinction coefficient (k), and herein, main factors determining the first reflection are a refractive index (n) and an absorption coefficient (k). Accordingly, the refractive index (n) and the absorption coefficient (k) are closely related to each other, and the effect may be maximized in the above-mentioned range.

According to one embodiment of the present specification, light reflectance of the electrode provided with the light reflection reducing layer may be 50% or less and more preferably 40% or less.

According to one embodiment of the present specification, the light reflection reducing layer may include one or more types selected from the group consisting of metal oxides, metal nitrides and metal oxynitrides. Specifically, according to one embodiment of the present specification, the light reflection reducing layer may include one or more types selected from the group consisting of metal oxides, metal nitrides and metal oxynitrides as a main material.

According to one embodiment of the present specification, the metal oxide, the metal nitride and the metal oxynitride may be derived from one, two or more metals selected from the group consisting of Cu, Al, Mo, Ti, Ag, Ni, Mn, Au, Cr and Co.

According to one embodiment of the present specification, the light reflection reducing layer may include a material selected from the group consisting of copper oxide, copper nitride and copper oxynitride.

According to one embodiment of the present specification, the light reflection reducing layer may include a material selected from the group consisting of aluminum oxide, aluminum nitride and aluminum oxynitride.

According to one embodiment of the present specification, the light reflection reducing layer may include copper-manganese oxide.

According to one embodiment of the present specification, the light reflection reducing layer may include copper-manganese oxynitride.

According to one embodiment of the present specification, the light reflection reducing layer may include copper-nickel oxide.

According to one embodiment of the present specification, the light reflection reducing layer may include copper-nickel oxynitride.

According to one embodiment of the present specification, the light reflection reducing layer may include molybdenum-titanium oxide.

According to one embodiment of the present specification, the light reflection reducing layer may include molybdenum-titanium oxynitride.

According to one embodiment of the present specification, the light reflection reducing layer may be formed in a single layer, or may be formed in a multilayer of two or more layers. The light reflection reducing layer preferably exhibits achromatic colors, but is not particularly limited thereto. Herein, the achromatic color means a color appearing when light entering to a surface of an object is evenly reflected and absorbed for a wavelength of each component instead of being selectively absorbed.

According to one embodiment of the present specification, the pixel electrode and the common electrode may include one, two or more metals selected from the group consisting of Cu, Al, Mo, Ti, Ag, Ni, Mn, Au, Cr and Co.

According to one embodiment of the present specification, the light reflection reducing layer may be an oxide, a nitride or an oxynitride of metals included in the pixel electrode and the common electrode. Specifically, according to one embodiment of the present specification, the light reflection reducing layer may include an oxide, a nitride or an oxynitride of metals mainly included in the pixel electrode and the common electrode as a main material.

When the pixel electrode and the common electrode, and the light reflection reducing layer include the same series of metals, there is an advantage in that batch etching may be readily carried out using the same etchant. In this case, the number of processes may be reduced compared to cases of patterning each, and high process efficiency may be accomplished by using the same etchant.

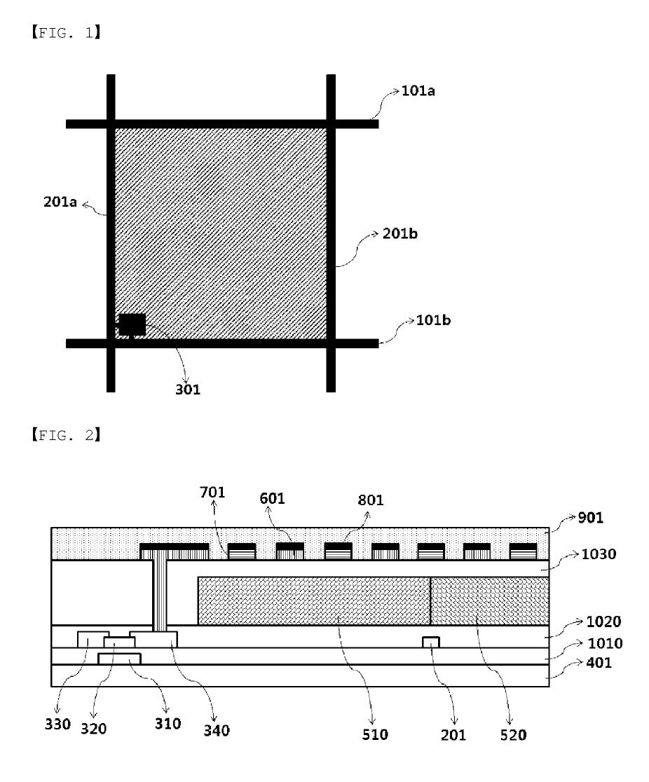

FIG. 1 illustrates an example of one pixel region of the present specification. Specifically, FIG. 1 illustrates a pixel region divided by a plurality of gate lines (101a, 101b) and a plurality of data lines (201a, 201b) provided on a substrate as a ribbed region. In addition, a thin film transistor (301) electrically connected to the gate line (101b) and the data line (201a) is provided in the pixel region, and electrical signals of each pixel region may be controlled.

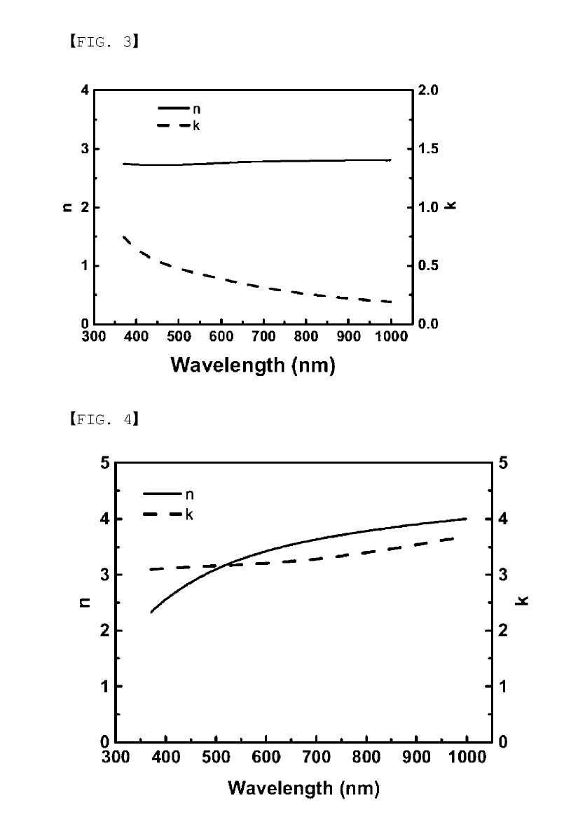

FIG. 2 illustrates a section of a liquid crystal display device according to one embodiment of the present specification. Specifically, a thin film transistor (301) formed with a gate electrode (310), a semiconductor layer (320), a source electrode (330) and a drain electrode (340) is provided on a substrate, a pixel region is divided by a gate line (not shown) connected to the gate electrode and a data line (201), and a color filter layer (510, 520) is provided in each of the pixel regions, and a common electrode (601) and a pixel electrode (701) are provided side by side on the color filter layer (510, 520) in each of the pixel regions. Furthermore, after providing a light reflection reducing layer (801) adjoining on each of the common electrode (601) and the pixel electrode (701), a liquid crystal orientation layer (901) is provided. In FIG. 2, a liquid crystal layer provided on the liquid crystal orientation layer (901) is not shown.

According to one embodiment of the present specification, the pixel electrode and the common electrode each include a plurality of conductive lines, and the pixel electrode and the common electrode may be provided in parallel to each other in the pixel region.

Specifically, according to one embodiment of the present specification, the pixel electrode and the common electrode may be alternately provided in each of the pixel regions. Accordingly, a horizontal electric field is formed in each of the pixel regions to drive liquid crystal molecules.

To the common electrode, a common voltage, a standard voltage for driving liquid crystals, is supplied, and accordingly, a horizontal electric field is formed between the pixel voltage signal-supplied pixel electrode and the common voltage-supplied common electrode, and liquid crystal molecules arranged in a parallel direction rotate by dielectric anisotropy. In addition, images may be obtained by changing transmissivity of light passing through the pixel region depending on the degree of rotation of the liquid crystal molecules.

According to one embodiment of the present specification, at least one of the pixel electrode and the common electrode may be provided on an overlapped portion of the color filter layer.

An overlapped portion of the color filter layer may mean a region in which color filters having different colors adjoin, and may mean a region in which different color filter layers (510, 520) adjoin in FIG. 2.

The pixel electrode or the common electrode being provided on an overlapped portion of the color filter layer has an advantage of preventing color mixing in the overlapped portion of the color filter layer when driving a display.

The color filter layer provided in each of the pixel regions may be a red, green or blue color filter layer. In addition, a white color filter layer may be provided in any one of the pixel regions as necessary. The red color filter layer, the green color filter layer, the blue color filter layer and the white color filter layer each form one unit pixel, and the one unit pixel may display images through light of colors emitted after penetrating the red color filter layer, the green color filter layer and the blue color filter layer.

According to one embodiment of the present specification, a thin film transistor each connected to the gate line and the data line is included in one side of each of the pixel regions.

According to one embodiment of the present specification, the thin film transistor is provided with a gate electrode branched off from the gate line, and a semiconductor layer provided by interposing an insulating layer on the gate electrode. Furthermore, the semiconductor layer is connected to a source electrode and a drain electrode by interposing an ohmic contact layer, and the source electrode is connected to the data line.

The gate line supplies scan signals from a gate driver, and the data line supplies video signals from a data driver.

One embodiment of the present specification provides a method for manufacturing the liquid crystal display device.

One embodiment of the present specification provides a method for manufacturing a liquid crystal display device including preparing a substrate; forming a plurality of gate lines and a plurality of data lines crossing each other to divide a plurality of pixel regions on the substrate; forming a color filter layer in each of the pixel regions; forming a pixel electrode and a common electrode on the color filter layer; forming a light reflection reducing layer on the pixel electrode and the common electrode; and forming a liquid crystal orientation layer on the color filter layer, the pixel electrode and the common electrode,

wherein one surface of the light reflection reducing layer adjoins the pixel electrode or the common electrode, the other surface of the light reflection reducing layer adjoins the liquid crystal orientation layer, and, in the light reflection reducing layer, the following Formula 1 satisfies a value of greater than or equal to 0.004 and less than or equal to 0.22.

$$\frac{( k \times t )}{λ} \qquad [ Formula 1 ]$$

In Formula 1, k means an extinction coefficient of the light reflection reducing layer, t means a thickness of the light reflection reducing layer, and λ means a wavelength of light.

Each constituent of the liquid crystal display device according to one embodiment of the present specification is the same as the constituent of the liquid crystal display device described above, and specific descriptions thereon are the same as provided above.

According to one embodiment of the present specification, the forming of a pixel electrode and a common electrode and the forming of a light reflection reducing layer may be carried out using a single patterning process.

According to one embodiment of the present specification, the patterning process may use materials having etching resist properties. The etching resist may form resist patterns using a printing method, a photolithography method, a photography method, a dry film resist method, a wet resist method, a method using a mask, laser transfer such as thermal transfer imaging, or the like, and specifically, a dry film resist method may be used. However, the method is not limited thereto. The pixel electrode, the common electrode and/or the light reflection reducing layer are etched and patterned using the etching resist pattern, and the etching resist pattern may be readily removed using a strip process.

According to one embodiment of the present specification, the single patterning process forms a first layer on the color filter layer using materials of the pixel electrode and the common electrode, and after forming a second layer on the electrode layer using a material of the light reflection reducing layer, the first layer and the second layer may be simultaneously patterned.

According to one embodiment of the present specification, the single patterning process may batch etch the first layer and the second layer using an etchant.

When using such a method, the light reflection reducing layer may be formed on the pixel electrode and the common electrode in a simple manner, and accordingly, a high-resolution liquid crystal display device may be obtained by reducing light reflectance of the pixel electrode and the common electrode.

Hereinafter, the present disclosure will be described in detail with reference to examples. However, the following examples are for illustrative purposes only, and the scope of the present disclosure is not limited thereto.

### Example 1

A MoTi layer having a thickness of 30 nm was formed on a glass substrate through a sputtering method using a MoTi (50:50 at %) alloy target, and a MoTi oxynitride layer having a thickness of 40 nm was formed thereon through a reactive sputtering method using a MoTi (50:50 at %) target. Reflectance of the deposited film was 9.4%.

A MoTi oxynitride single layer was formed on a glass substrate in the same manner in order to obtain a light absorption coefficient (k) value. After that, a refractive index and a light absorption coefficient were measured using an ellipsometer. n and k values at 380 nm to 1000 nm were as shown in FIG. 3, and the light absorption coefficient value at 550 nm was 0.43. When putting these values in Formula 1, a value of 0.031 was calculated.

### Examples 2 to 12

Experiments were carried out in the same manner as in Example 1 except that the thickness of the MoTi oxynitride was as in the following Table 1. In Examples 2 to 12, optical simulation was performed through the MacLeod program. The optical constant value of Example 1 was put on the program to obtain a reflectance value when the MoTi oxynitride layer had a thickness as follows, and the value of Formula 1 and the reflectance are shown in the following Table 1.

TABLE 1

| | MoTi Oxynitride | Value of | Reflectance |
|---|---|---|---|
| | Layer Thickness (nm) | Formula 1 | (%) |
| Example 2 | 5.5 | 0.0043 | 52 |
| Example 3 | 10 | 0.0078 | 46 |
| Example 4 | 15 | 0.0117 | 39 |
| Example 5 | 20 | 0.0156 | 31 |
| Example 6 | 25 | 0.0195 | 23 |
| Example 7 | 30 | 0.0235 | 18 |
| Example 8 | 35 | 0.0274 | 14 |
| Example 9 | 60 | 0.0469 | 17 |
| Example 10 | 70 | 0.0547 | 23 |
| Example 11 | 80 | 0.0625 | 27 |
| Example 12 | 100 | 0.078 | 31 |

### Comparative Example 1

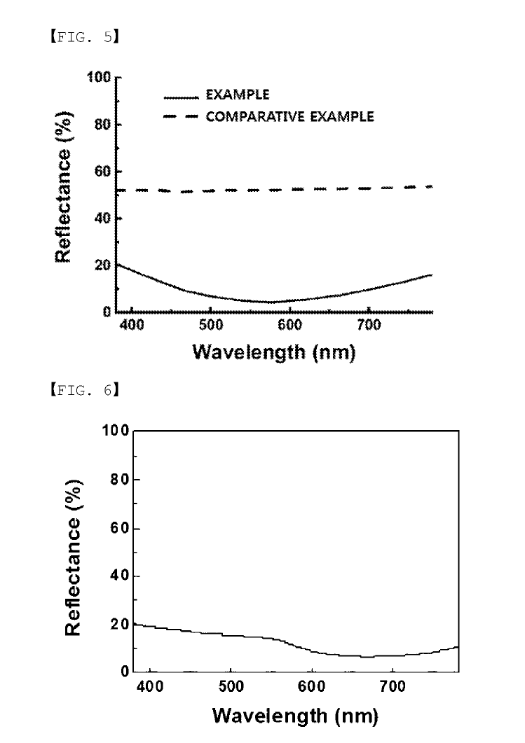

A MoTi layer having a thickness of 30 nm was formed on a glass substrate through a sputtering method using a MoTi (50:50 at %) alloy target. Reflectance of the deposited film was 52%. A MoTi single layer was formed on a glass substrate in the same manner in order to obtain a light absorption coefficient (k) value. After that, a refractive index and a light absorption coefficient were measured using an ellipsometer. n and k values at 380 nm to 1000 nm were as shown in FIG. 4, and the light absorption coefficient value at 550 nm was 3.18. When putting these values in Formula 1, a value of 0.23 was calculated. A graph comparing the reflectance of Example 1 and Comparative Example 1 is shown in FIG. 5.

### Comparative Example 2

An experiment was carried out in the same manner as in Example 1 except that the MoTi oxynitride layer thickness was 4 nm. The value of Formula 1 was calculated as 0.003. The reflectance was 53%.

### Example 13

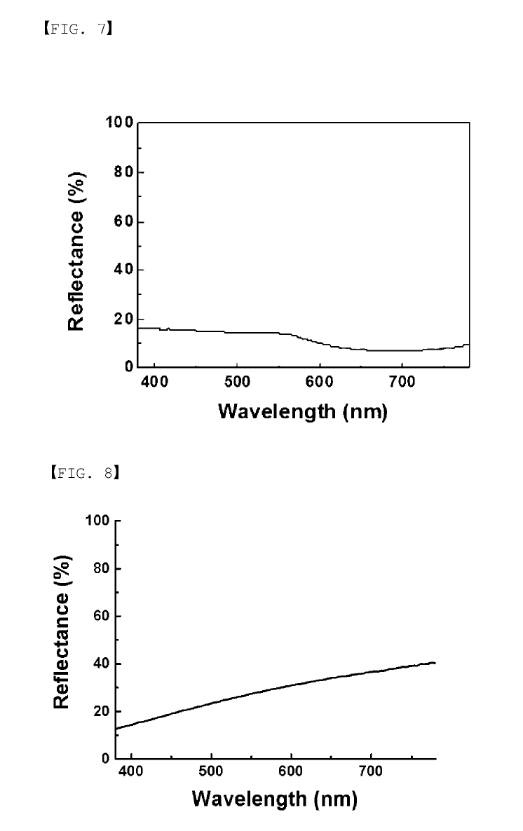

A Cu layer having a thickness of 60 nm was formed as a conductive layer on a glass substrate through a DC sputtering method using a Cu single target, and a light reflection reducing layer having a thickness of 35 nm and including MoTiₐNₓO_{y} (0<a≦2, 0<x≦3, 0<y≦2) was formed through a reactive DC sputtering method using a MoTi (50:50 at %) alloy target. Wavelength-dependent total reflectance was measured through simulation using Solidspec 3700 (UV-Vis spectrophotometer, Shimadzu Corporation), and the results are shown in FIG. 6. The value of Formula 1 of the light reflection reducing layer was 0.059.

### Example 14

A Cu layer having a thickness of 60 nm was formed as a first conductive layer on a glass substrate through a DC sputtering method using a Cu single target, and a MoTi layer having a thickness of 20 nm was formed as a second conductive layer through a DC sputtering method using a MoTi (50:50 at %) alloy target, and using the same target, a light reflection reducing layer having a thickness of 35 nm and including MoTiₐNₓO_{y} (0<a≦2, 0<x≦3, 0<y≦2) was formed through a reactive DC sputtering method. Wavelength-dependent total reflectance was measured through simulation using Solidspec 3700 (UV-Vis spectrophotometer, Shimadzu Corporation), and the results are shown in FIG. 7. The value of Formula 1 of the light reflection reducing layer was 0.059.

### Example 15

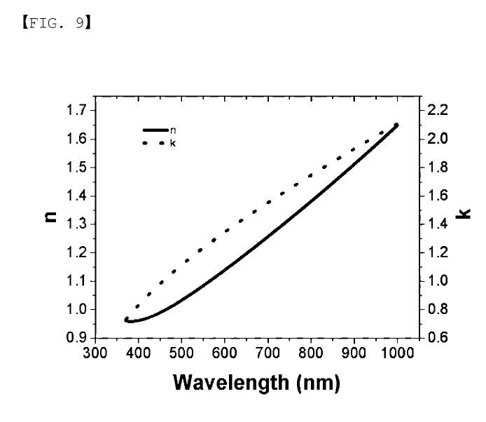

An experiment was carried out in the same manner as in Example 1 except that an Al layer depositing Al was used instead of the MoTi layer, and aluminum oxynitride (k=1.24) was used instead of the MoTi oxynitride to form into a thickness of 87 nm. Herein, the value of Formula 1 was 0.2, and the reflectance was approximately 28%. FIGS. 8 and 9 show the reflectance and the optical constant value obtained from the structure.

Through the test results of the examples and the comparative examples, it was identified that excellent effects of the light reflection reducing layer were obtained in the structures described in the claims of the present application.

1. A liquid crystal display device comprising:
a substrate;
a plurality of gate lines and a plurality of data lines provided to cross each other on the substrate;
a plurality of pixel regions divided by the gate lines and the data lines;
a color filter layer provided on each of the pixel regions;
a pixel electrode and a common electrode corresponding thereto provided on the same plane of each of the color filter layers;
a liquid crystal orientation layer provided on the color filter layer, the pixel electrode and the common electrode; and
a light reflection reducing layer provided each of between the liquid crystal orientation layer and the pixel electrode and between the liquid crystal orientation layer and the common electrode,
wherein one surface of the light reflection reducing layer adjoins the pixel electrode or the common electrode, the other surface of the light reflection reducing layer adjoins the liquid crystal orientation layer, and
in the light reflection reducing layer, the following Formula 1 satisfies a value of greater than or equal to 0.004 and less than or equal to 0.22:
$$\frac{( k \times t )}{λ} \qquad [ Formula 1 ]$$
wherein, in Formula 1, k means an extinction coefficient of the light reflection reducing layer, t means a thickness of the light reflection reducing layer, and λ means a wavelength of light.

2. The liquid crystal display device of claim 1, wherein the light reflection reducing layer has a thickness of greater than or equal to 10 nm and less than or equal to 100 nm.

3. The liquid crystal display device of claim 1, wherein the light reflection reducing layer has an extinction coefficient (k) of greater than or equal to 0.1 and less than or equal to 2 in light with a wavelength of 550 nm.

4. The liquid crystal display device of claim 1, wherein the light reflection reducing layer has a refractive index (n) of greater than or equal to 2 and less than or equal to 3 in light with a wavelength of 550 nm.

5. The liquid crystal display device of claim 1, wherein light reflectance of the electrode provided with the light reflection reducing layer is 50% or less.

6. The liquid crystal display device of claim 1, wherein the light reflection reducing layer includes one or more types selected from the group consisting of metal oxides, metal nitrides and metal oxynitrides.

7. The liquid crystal display device of claim 6, wherein the metal oxide, the metal nitride and the metal oxynitride are derived from one, two or more metals selected from the group consisting of Cu, Al, Mo, Ti, Ag, Ni, Mn, Au, Cr and Co.

8. The liquid crystal display device of claim 1, wherein the pixel electrode and the common electrode include one, two or more metals selected from the group consisting of Cu, Al, Mo, Ti, Ag, Ni, Mn, Au, Cr and Co.

9. The liquid crystal display device of claim 1, wherein the light reflection reducing layer is an oxide, a nitride or an oxynitride of metals included in the pixel electrode and the common electrode.

10. The liquid crystal display device of claim 1, wherein the pixel electrode and the common electrode each include a plurality of conductive lines, and the pixel electrode and the common electrode are provided in parallel to each other in the pixel region.

11. The liquid crystal display device of claim 10, wherein at least one of the pixel electrode and the common electrode is provided on an overlapped portion of the color filter layer.

12. A method for manufacturing a liquid crystal display device comprising:
preparing a substrate;
forming a plurality of gate lines and a plurality of data lines crossing each other to divide a plurality of pixel regions on the substrate;
forming a color filter layer in each of the pixel regions;
forming a pixel electrode and a common electrode on the color filter layer;
forming a light reflection reducing layer on the pixel electrode and the common electrode; and
forming a liquid crystal orientation layer on the color filter layer, the pixel electrode and the common electrode,
wherein one surface of the light reflection reducing layer adjoins the pixel electrode or the common electrode, the other surface of the light reflection reducing layer adjoins the liquid crystal orientation layer, and
in the light reflection reducing layer, the following Formula 1 satisfies a value of greater than or equal to 0.004 and less than or equal to 0.22:
$$\frac{( k \times t )}{λ} \qquad [ Formula 1 ]$$
wherein, in Formula 1, k means an extinction coefficient of the light reflection reducing layer, t means a thickness of the light reflection reducing layer, and λ means a wavelength of light.

13. The method for manufacturing a liquid crystal display device of claim 12, wherein the forming of a pixel electrode and a common electrode and the forming of a light reflection reducing layer are carried out using a single patterning process.

14. The method for manufacturing a liquid crystal display device of claim 13, wherein the single patterning process forms a first layer on the color filter layer using materials of the pixel electrode and the common electrode, and after forming a second layer on the electrode layer using a material of the light reflection reducing layer, the first layer and the second layer are simultaneously patterned.

15. The method for manufacturing a liquid crystal display device of claim 14, wherein the single patterning process batch etches the first layer and the second layer using an etchant.
